(19) United States
(12) Patent Application Publication
(10) Pub. No.: US 2025/0115692 A1
(43) Pub. Date: Apr. 10, 2025

(54) OLEFIN-BASED POLYMER

(71) Applicant: SUMITOMO CHEMICAL COMPANY, LIMITED, Tokyo (JP)

(72) Inventors: Kohi KUDO, Chiba (JP); Toshiki MURAYAMA, Chiba (JP); Shingo KATAYAMA, Chiba (JP)

(21) Appl. No.: 18/903,359

(22) Filed: Oct. 1, 2024

(30) Foreign Application Priority Data
Oct. 4, 2023 (JP) 2023-172889

(51) Int. Cl. C08F 210/16; C08F 2/00; C08F 2/02; C08F 2/34

(52) U.S. Cl. CPC C08F 210/16; C08F 2/001; C08F 2/02; C08F 2/34; C08F 2400/04

(57) ABSTRACT

An olefin-based polymer has an S value of 0.60 or more. The S value is calculated using formula (i):

$$[ Formula 1 ]$$

$$S = \frac{y - value at GA - y - value at LA min}{x - value at GA - x - value at LA min} / T \qquad ( i )$$

LA min is a minimum at lowest x, and LA max is a minimum at highest x on a first derivative curve obtained by a Savitzky-Golay method from a molecular weight distribution curve where an x-axis represents a log value (log A) of a molecular size (A) determined by gel permeation chromatography and a y-axis represents a polymer concentration fraction (dW/d log A) against the log value. GA is a point at a highest y in a range of an x-value at LA min or more and an x-value at LA max or less, and T is an area of the molecular weight distribution curve.

### BACKGROUND OF THE INVENTION

### Field of the Invention

The present invention relates to an olefin-based polymer.

### Description of the Related Art

In the related art, olefin-based polymers are used for, for example, food packaging materials, pharmaceutical packaging materials, electronic component packaging materials, surface protection materials, and insulators and sheaths for electrical wires, cables, and other products.

For example, JP-A-2008-106264 discloses an ethylene-α-olefin copolymer with specific ranges of melt flow rate, density, flow activation energy, molecular weight distribution, and hexane extraction amount, wherein the ethylene-α-olefin copolymer can be used for food packaging materials and exhibits good moldability and low smoke emission during melt processing.
Patent Document 1: JP-A-2008-106264

### SUMMARY OF THE INVENTION

### Problem to be Solved by the Invention

However, the olefin-based polymer disclosed in JP-A-2008-106264 requires further improvements in moldability.

In light of such a circumstance, the present invention is directed to an olefin-based polymer that is relatively easy to mold.

### Means for Solving the Problem

An olefin-based polymer according to the present invention has an S value of 0.60 or more, wherein the S value is calculated using formula (i):

$$[ Formula 1 ]$$

$$S = \frac{y - value at GA - y - value at LA min}{x - value at GA - x - value at LA min} / T \qquad ( i )$$

wherein LA min is a minimum at the lowest x, and LA max is a minimum at the highest x on the first derivative curve obtained by the Savitzky-Golay method from the molecular weight distribution curve where the x-axis represents the log value (log A) of the molecular size (A) determined by gel permeation chromatography, and the y-axis represents the polymer concentration fraction (dW/d log A) against the log value. GA is a point at the highest y in the range of the x-value at LA min or more and the x-value at LA max or less, and T is the area of the molecular weight distribution curve.

### Effect of the Invention

The present invention can provide an olefin-based polymer that is relatively easy to mold.

### DETAILED DESCRIPTION OF THE PREFERRED EMBODIMENTS

Embodiments of the present invention will be described below, but the present invention is not limited to the following embodiments.

To improve moldability, an olefin-based polymer according to an embodiment has an S value, which is calculated using formula (i), of 0.60 or more, preferably 1.0 or more, more preferably 1.4 or more. To improve moldability, the olefin-based polymer preferably has an S value of 2.0 or less, more preferably 1.8 or less, still more preferably 1.4 or less.

$$[ Formula 2 ]$$

$$S = \frac{y - value at GA - y - value at LA min}{x - value at GA - x - value at LA min} / T \qquad ( i )$$

In formula (i), LA min is a minimum at the lowest x, and LA max is a minimum at the highest x on the first derivative curve obtained by the Savitzky-Golay method from the molecular weight distribution curve where the x-axis represents the log value (log A) of the molecular size (A) determined by gel permeation chromatography, and the y-axis represents the polymer concentration fraction (dW/d log A) against the log value. GA is a point at the highest y in the range of the x-value at LA min or more and the x-value at LA max or less, and T is the area of the molecular weight distribution curve. The number of minimums in the first derivative curve is preferably two. If the number of minimums in the first derivative curve is less than 2, S=0.

The S value can be increased by, for example, reducing the partial pressure of a main monomer in gas phase polymerization. The S value can be reduced by, for example, increasing the partial pressure of the main monomer in gas phase polymerization.

The S value can be calculated by using the following method. First, the GPC chromatogram is obtained by the method described below. The baseline on the chromatogram is specified based on the description in ISO16014-1. The S value can be calculated by the following method using Python. In the first step, an Anaconda version of the corresponding model is downloaded and installed, and the environment settings are made.

In the second step, the title of the first column of the electronic data of the GPC chromatogram is assigned to “x,” and the title of the second column is assigned to “y.” Next, the log M values are inputted in the second and subsequent rows in the first column, and the dwt/d (log M) values are inputted in the second and subsequent rows in the second column. The data are stored as a csv file (“data name .csv”).

In the third step, the code described below is inputted and executed by using Jupyter Notebook (Anaconda 3).

```
      # load module
      import glob
      import pandas as pd
      from scipy import signal
      # input Data
      df = pd.read_csv(‘data name.csv’)
      # execute smoothing and differentiation
      delta = df[“x”].iat[1] − df[“x”].iat[0]
      df[“dy”] = signal.savgol_filter(df[“y”],
round((0.3/delta − 1)/2) * 2 + 1, 1, deriv=1, delta=delta)
      df[“ddy”] = signal.savgol_filter(df[“y”],
round((0.6/delta − 1)/2) * 2 + 1, 2, deriv=2, delta=delta)
      # calculate S value
      l_mins =[ ]
      idxmax = df[“y”].astype(“float 64”).idxmax( )
      for i in range(len(df[“ddy”]) − 1 − idxmax):
      if df.at[df.index[i + idxmax], “ddy”] < 0 and
df.at[df.index[i + idxmax + 1], “ddy”] > 0:
      l_mins.append(i + idxmax)
      if len(l_mins) < 2:
      s = 0
      else:
      first_l_min_idx = min(l_mins)
      first_l_min_x = df.at[df.index[first_l_min_idx], “x”]
      first_l_min_y = df.at[df.index[first_l_min_idx], “dy”]
      last_l_min_idx = max(l_mins)
      last_l_min_x = df.at[df.index[last_l_min_idx], “x”]
      last_l_min_y = df.at[df.index[last_l_min_idx], “dy”]
      partial_df = df.query(“@first_l_min_idx < index <
@last_l_min_idx”)
      partial_max_idx = partial_df[“dy”].idxmax( )
      partial_max_x = df.at[df.index[partial_max_idx], “x”]
      partial_max_y = df.at[df.index[partial_max_idx], “dy”]
      s = (partial_max_y − first_l_min_y)/(partial_max_x −
first_l_min_x)
      print(s)
```

To improve moldability, the crystallization temperature of the olefin-based polymer according to this embodiment is preferably 99.0° C. or higher and 105.0° C. or lower, more preferably 100.0° C. or higher and 104.0° C. or lower, still more preferably 101.0° C. or higher and 103.0° C. or lower. The crystallization temperature can be increased by, for example, reducing the ratio of a comonomer to the main monomer in polymerization. The crystallization temperature can be reduced by, for example, increasing the ratio of the comonomer to the main monomer in polymerization.

The crystallization temperature can be measured by the method including stages 1) to 3) below using a differential scanning calorimeter (DSC Q100, available from TA Instruments). The crystallization temperature can be determined at the exothermic peak in the heat flow curve observed in the stage 2).
1) Hold about 10 mg of a sample at 150° C. for 5 minutes in a nitrogen atmosphere.
2) Cool from 150° C. to 20° C. or 0° C. (5° C./min) and hold at 20° C. or 0° C. for 2 minutes.
3) Heat from 20° C. or 0° C. to 150° C. (5° C./min).

In the olefin-based polymer according to this embodiment, the ratio (Mz/Mw) of the z-average molecular weight (Mz) to the weight average molecular weight (Mw) determined by gel permeation chromatography is preferably 2.5 or more and 2.8 or less, more preferably 2.6 or more and 2.8 or less, still more preferably 2.7 or more and 2.8 or less, to improve moldability.

In the olefin-based polymer according to this embodiment, the ratio (Mw/Mn) of the weight average molecular weight (Mw) to the number average molecular weight (Mn) determined by gel permeation chromatography is preferably 3.4 or more and 4.0 or less, more preferably 3.5 or more and 3.9 or less, still more preferably 3.6 or more and 3.8 or less, to improve moldability.

The weight average molecular weight (Mw), the number average molecular weight (Mn), and the z-average molecular weight (Mz) can be determined by gel permeation chromatography (GPC) under the following conditions.

### Measurement Conditions

Apparatus: HLC-8321GPC/HT (available from Tosoh Corporation)

GPC column: TOSOH TSKgel GMH_{HR}-H(S) HT 7.8 I.D.×300 mm (available from Tosoh Corporation), three columns Mobile phase: ortho-dichlorobenzene (available from Wako Pure Chemical Industries, Ltd., Guaranteed Reagent) with 0.1 w/V BHT
Flow rate: 1 mL/min
Column oven temperature: 140° C.
Detection: refractive index detector (RID)
RID cell temperature: 140° C.
Sample solution injection volume: 300 UL
Sample solution concentration: 5 mg/mL

Standard substance for GPC column calibration: prepared by dissolving standard polystyrene, which is available from Tosoh Corporation, at the weight shown in Table 1 in 5 mL of ortho-dichlorobenzene (with the same composition as the mobile phase) at room temperature

TABLE 1

| | | | | | | |
|---|---|---|---|---|---|---|
| 1 | F700 | 0.4 mg | F20 | 0.9 mg | A5000 | 1.2 mg |
| 2 | F288 | 0.4 mg | F10 | 1.0 mg | A2500 | 1.2 mg |
| 3 | F80 | 0.7 mg | F4 | 1.1 mg | A1000 | 1.3 mg |
| 4 | F40 | 0.8 mg | F2 | 1.1 mg | A500 | 1.3 mg |

When the olefin-based polymer according to this embodiment is a copolymer described below, the number of long-chain branches (LCB) per 1,000 carbon atoms (LCB/1000C) in the copolymer is preferably 0.19 or more and 0.25 or less, more preferably 0.21 or more and 0.23 or less. LCB/1000C can be increased by, for example, reducing the partial pressure of the main monomer in gas phase polymerization. LCB/1000C can be reduced by, for example, increasing the partial pressure of the main monomer in gas phase polymerization.

LCB/1000C can be determined by measuring the carbon nuclear magnetic resonance (13C-NMR) spectrum of the copolymer under the following measurement conditions.
Measurement Conditions
Apparatus: Bruker AVANCE 600
Measurement probe: 10 mm CryoProbe
Measurement solvent: 1,2-dichlorobenzene-d4
Measurement temperature: 135° C.
Measurement method: proton decoupling method
Pulse width: 45 degrees
Pulse repetition time: 4 seconds
Window functions: negative exponential function and

### Gaussian Function

Number of scans: 5000

Method for Calculating the Number of Long-Chain Branches (LCB)

In the 13C-NMR spectrum, the peak area of the peak corresponding to methine carbon bonded to branches of 7 or more carbon atoms when the total peak area of all the peaks having peak tops from 5 to 50 ppm is set to 1,000 is defined as LCB. LCB is the number of branches of 7 or more carbon atoms per 1,000 carbon atoms in the copolymer. In the above measurement conditions, the peak area A near 38.2 ppm in analysis using the exponential function is used as a reference, and the area near 38.2 ppm is defined as the peak area A in analysis using the Gaussian function. On the basis of this, LCB can be obtained from the peak area of a newly appearing peak having a peak top in the range of 38.22 to 38.27 ppm. In processing using the Gaussian function, the line broadening factor (LB) is from −3 to −0.1. The peak area of this peak is the area of signals in the range from the chemical shift of a valley between a peak at the highest magnetic field among peaks in the above range and its adjacent peak at the higher magnetic field than the peak to the chemical shift of a valley between a peak at the lowest magnetic field among peaks in the above range and its adjacent peak at the lower magnetic field than the peak.

When the olefin-based polymer according to this embodiment is the copolymer described below, the number of short-chain branches (SCB) per 1,000 carbon atoms (SCB/1000C) in the copolymer is preferably 18.8 or less, more preferably 5.0 or more and 18.8 or less, still more preferably 10.0 or more and 18.8 or less. SCB/1000C can be increased by, for example, increasing the ratio of the comonomer to the main monomer in polymerization. SCB/1000C can be reduced by, for example, reducing the ratio of the comonomer to the main monomer in polymerization.

SCB/1000C can be obtained by calculating, as a short-chain branching amount, the peak area corresponding to methine carbon bonded to branches of 4 carbon atoms when the total peak area of all the peaks having peak tops from 5 to 50 ppm in analysis using the exponential function in the carbon nuclear magnetic resonance (13C-NMR) spectrum measured by the above method is set to 1,000.

When the olefin-based polymer according to this embodiment is the copolymer described below, the number of trisubstituted unsaturated bonds in the copolymer is preferably 0.001 or more and 0.010 or less, more preferably 0.003 or more and 0.008 or less, still more preferably 0.005 or more and 0.006 or less. The number of trisubstituted unsaturated bonds in the copolymer can be increased by, for example, increasing the ratio of the comonomer to the main monomer in polymerization. The number of trisubstituted unsaturated bonds in the copolymer can be reduced by, for example, reducing the ratio of the comonomer to the main monomer in polymerization.

The number of trisubstituted unsaturated bonds in the copolymer can be determined by measuring the proton nuclear magnetic resonance (1H-NMR) spectrum of the copolymer under the following measurement conditions.
Measurement Conditions
Apparatus: Bruker AVANCE 600
Measurement probe: 10 mm CryoProbe
Measurement solvent: 1,2-dichlorobenzene-d4
Measurement temperature: 135° C.
Sample concentration: 60 mg/mL
Number of scans: 64

Method for Calculating the Number of Trisubstituted Unsaturated Bonds

In the 1H-NMR spectrum, the peak area corresponding to the trisubstituted unsaturated bonds when the total peak area of all the peaks having peak tops from 3.0 to −0.5 ppm is set to 1,000 can be calculated as the number of trisubstituted unsaturated bonds.

To improve moldability, the limiting viscosity of the olefin-based polymer according to this embodiment is preferably 1.19 dl/g or more, more preferably 1.19 dl/g or more and 1.80 dl/g or less, still more preferably 1.19 dl/g or more and 1.60 dl/g or less. The limiting viscosity can be increased by, for example, reducing the ratio of hydrogen to the main monomer in polymerization. The limiting viscosity can be reduced by, for example, increasing the ratio of hydrogen to the main monomer in polymerization. The limiting viscosity can be measured at 135° C. with an Ubbelohde viscometer using a solution of the polymer in tetralin.

The characteristic relaxation time of the olefin-based polymer according to this embodiment is preferably 10.2 sec or more, more preferably 10.2 sec or more and 18.0 sec or less, still more preferably 10.2 sec or more and 16.0 sec or less. The characteristic relaxation time can be increased by, for example, reducing the ratio of hydrogen to the main monomer in polymerization. The characteristic relaxation time can be reduced by, for example, increasing the ratio of hydrogen to the main monomer in polymerization.

The characteristic relaxation time can be determined by the following method. First, the melt complex viscosity-angular frequency curves at 130° C., 150° C., 170° C., and 190° C. are measured under the following measurement conditions using a viscoelasticity analyzer ARES-G2 (available from TA Instruments). Next, the master curve of the melt complex viscosity-angular frequency curve at 190° C. is produced from the obtained melt complex viscosity-angular frequency curve using analysis software TRIOS ver. 5.0.0 (available TA Instruments), and the obtained master curve is approximated by the following formula to obtain the characteristic relaxation time.

$$η = η 0 / [ 1 + {( τ \times ω )}^{n} ]$$

n: melt complex viscosity (unit: Pa·see)
ω: angular frequency (unit: rad/sec)
T: characteristic relaxation time (unit: see)
no: constant (unit: Pa·sec) for each ethylene-α-olefin copolymer
n: constant for each ethylene-α-olefin copolymer
Measurement Conditions
Geometry: parallel plate
Plate diameter: 25 mm
Plate interval: 1.5 to 2 mm
Strain: 5%
Angular frequency: 100 to 0.1 rad/see
Measurement atmosphere: nitrogen

To appropriately control the extrusion load during extrusion, the melt complex viscosity (n*100) of the olefin-based polymer according to this embodiment is preferably 5,000 Pa·see or less, more preferably 3,000 Pa·sec or less, still more preferably 2,000 Pa·sec or less. To improve moldability, the melt complex viscosity (n*100) is preferably 300 Pa·see or more, more preferably 500 Pa·see or more, still more preferably 1,000 Pa·see or more.

To make the working environment better to improve moldability, the oligomer content of the olefin-based polymer according to this embodiment is preferably 1500 ppm or less, more preferably 1200 ppm or less, still more preferably 800 ppm or less.

The oligomer content can be determined by the following method. First, oligomer components are extracted from about 1 g of the polymer by ultrasonic extraction using 10 ml of THF solvent. The oligomer components can be quantified by GC. The measurement apparatus and the measurement conditions are as described below.
Measurement Conditions
GC system: Shimadzu Corporation GC-2025
Column: GL Sciences InertCap1
(film thickness 1.50 μm, length 15 m, inner diameter 0.53 mm)
Detector (FID) temperature: 310° C.
Measurement column temperature: hold at 100° C. for 1 minute and then heat to 310° C. at 10° C./min

The total detection peak area for C12-C18 hydrocarbons in the obtained gas chromatogram chart is converted into C18 hydrocarbon concentration (ppm).

The olefin-based polymer is, for example, an ethylene-based polymer or a propylene-based polymer. The olefin-based polymer is preferably an ethylene-based polymer. Olefin-based polymers may be used singly or in combination of two or more.

### Ethylene-Based Polymer

The ethylene-based polymer is a polymer including more than 50 mass % of a monomer unit derived from ethylene, that is, ethylene homopolymer, or an ethylene-based copolymer including more than 50 mass % of a monomer unit derived from ethylene. Examples of monomer units other than ethylene contained in the ethylene-based copolymer include monomer units derived from C3-C20 α-olefins. Ethylene-based polymers may be used singly or in combination of two or more.

The ethylene-based polymer is preferably an ethylene-α-olefin copolymer obtained by copolymerization of ethylene and a C3-C20 α-olefin. The C3-C20 α-olefin is, for example, propylene, 1-butene, 1-pentene, 1-hexene, 1-heptene, 1-octene, 1-nonene, 1-decene, 1-dodecene, 4-methyl-1-pentene, or 4-methyl-1-hexene, preferably propylene, 1-butene, or 1-hexene. These C3-C20 α-olefins may be used singly or in combination of two or more.

In the ethylene-α-olefin copolymer, the α-olefin may contain at least one selected from the group consisting of propylene, butene, and hexene. Such an ethylene-α-olefin copolymer is, for example, an ethylene-propylene copolymer, an ethylene-1-butene copolymer, an ethylene-1-hexene copolymer, an ethylene-propylene-1-butene copolymer, or an ethylene-1-butene-1-hexene copolymer, preferably an ethylene-1-butene copolymer, an ethylene-1-hexene copolymer, or an ethylene-1-butene-1-hexene copolymer.

The content of the ethylene-based monomer unit in the ethylene-α-olefin copolymer is typically more than 50 mass % and 99 mass % or less relative to the total mass (100 mass %) of the ethylene-α-olefin copolymer. The content of the C3-C20-α-olefin-based monomer unit in the ethylene-α-olefin copolymer is typically 1 mass % or more and less than 50 mass % relative to the total mass (100 mass %) of the ethylene-α-olefin copolymer.

The melt flow rate (MFR) of the ethylene-based polymer measured at a temperature of 190° C. and a load of 2.16 kg is preferably 0.10 g/10 min or more and 10.00 g/10 min or less, more preferably 0.20 g/10 min or more and 10.00 g/10 min or less. The MFR is measured in accordance with the method A specified in JIS K7210-1995.

The density of the ethylene-based polymer is typically 870 kg/m³ or more and 960 kg/m³ or less. To improve the mechanical strength of molded bodies, the density is preferably 940 kg/m³ or less, more preferably 930 kg/m³ or less, still more preferably 925 kg/m³ or less, yet still more preferably 920 kg/m³ or less. To improve the heat resistance of molded bodies, the density is preferably 880 kg/m³ or more, more preferably 890 kg/m³ or more. The density is measured in accordance with the method specified in JIS K7112-1980.

The ethylene homopolymer is preferably produced by a so-called “high-pressure method.” The production of the ethylene homopolymer by the “high-pressure method” is typically carried out by polymerization of ethylene in the presence of a radical generator at a polymerization pressure of 140 to 300 MPa and a polymerization temperature of 200 to 300° C. in a tank reactor or a tubular reactor.

Examples of the method for producing the ethylene-α-olefin copolymer include copolymerization of ethylene and an α-olefin in the presence of a polymerization catalyst composed of, as catalyst components, a carrier having a co-catalyst component, such as an organoaluminum compound or an organoaluminum oxy-compound, supported on a particle carrier, and a metallocene complex having a ligand with two cyclopentadienyl anion skeletons bonded to each other through a cross-linking group, such as an alkylene group or a silylene group.

The polymerization catalyst composed of the carrier and the metallocene complex may be used in combination with an organoaluminum compound, which serves as a catalyst component, as appropriate. Examples of the organoaluminum compound include triisobutylaluminum and tri-n-octylaluminum. In the system in which the organoaluminum compound is used in combination as a catalyst component, a polymer that has relatively high melt tension and is easy to mold can be produced. In the system in which no organoaluminum compound is used in combination as a catalyst component, a polymer that provides a better working environment and is easy to mold can be obtained due to a relatively low oligomer content.

Examples of the polymerization method include gas phase polymerization and slurry polymerization. Examples of solvents used in slurry polymerization include aliphatic hydrocarbon solvents, such as butane, pentane, hexane, heptane, and octane; and aromatic hydrocarbon compounds, such as benzene and toluene. The solvent used in slurry polymerization is preferably butane. Preferably, the solvent used in slurry polymerization is not removed after contact of the carrier with the metallocene complex.

The main polymerization may be preceded by prepolymerization. The prepolymerized prepolymerization catalyst component is preferably used as a catalyst component or a catalyst in the main polymerization.

The polymerization temperature is typically lower than the melting temperature of the ethylene-α-olefin copolymer, preferably 0° C. or higher and 150° C. or lower, more preferably 30° C. or higher and 100° C. or lower, still more preferably 50° C. or higher and 90° C. or lower. The polymerization time is typically 1 hour or more and 20 hours or less.

### Propylene-Based Polymer

The propylene-based polymer is a polymer including more than 50 mass of a monomer unit derived from propylene. Examples of the propylene-based polymer include a propylene homopolymer, a random copolymer of propylene and a monomer other than propylene, and a heterophasic propylene polymer material. Propylene-based polymers may be used singly or in combination of two or more.

The propylene homopolymer can be produced by, for example, a polymerization step of polymerizing propylene using a polymerization catalyst.

Examples of the polymerization catalyst include Ziegler catalysts; Ziegler-Natta catalysts; a catalyst containing an alkylaluminoxane and a Group 4 transition metal compound having a cyclopentadienyl ring; a catalyst containing a Group 4 transition metal compound having a cyclopentadienyl ring, a compound that reacts with the transition metal compound to form an ionic complex, and an organoaluminum compound; and a catalyst produced by modifying inorganic particles (e.g., silica, clay minerals) with a catalyst component (e.g., a Group 4 transition metal compound having a cyclopentadienyl ring, a compound that forms an ionic complex, an organoaluminum compound) such that the catalyst component is supported on the inorganic particles.

Examples of the polymerization catalyst include catalysts disclosed in JP-A-61-218606, JP-A-5-194685, JP-A-7-216017, JP-A-9-316147, JP-A-10-212319, JP-A-2004-182981, JP-A-2010-168545, and JP-A-2011-246699.

A polymer prepared by prepolymerization of propylene in the presence of the above polymerization catalyst can also be used as a polymerization catalyst.

Examples of the polymerization method include bulk polymerization, solution polymerization, and gas phase polymerization. Bulk polymerization refers to polymerization using, as a medium, an olefin in the form of liquid at a polymerization temperature. Solution polymerization refers to polymerization in an inert hydrocarbon solvent, such as propane, butane, isobutane, pentane, hexane, heptane, or octane. Gas phase polymerization refers to polymerization of a gaseous monomer in a medium composed of the gaseous monomer.

Examples of the type of polymerization include batch polymerization, continuous polymerization, and a combination thereof. The type of polymerization may be multi-stage polymerization using two or more polymerization reactors connected in series.

From industrial and economical point of view, the polymerization method is preferably continuous gas phase polymerization, or bulk-gas phase polymerization in which bulk polymerization and gas phase polymerization are performed continuously.

Various conditions (polymerization conditions, such as polymerization temperature, polymerization pressure, monomer concentration, catalyst loading amount, polymerization time) in the polymerization step are appropriately set according to the molecular structure of the intended polymer.

The method for producing the propylene homopolymer may include another step before or after the polymerization step. For example, to remove the residual solvent contained in the polymer and ultra-low molecular weight oligomers generated as by-products during production, the polymer may be dried at a temperature equal to or lower than the melting temperature of the polymer as desired after the polymerization step. Examples of the drying method include the methods described in JP-A-55-75410 and Japanese Patent No. 2565753.

Examples of the monomer unit other than propylene in the random copolymer of propylene and a monomer other than propylene include ethylene and C4-C12 α-olefins. Examples of the C4-C12 α-olefins include 1-butene, 1-pentene, 1-hexene, 1-heptene, 1-octene, 1-nonene, 1-decene, 1-dodecene, 4-methyl-1-pentene, and 4-methyl-1-hexene.

The random copolymer of propylene and a monomer other than propylene can be produced by, for example, polymerizing propylene and a monomer other than propylene using the polymerization catalyst, the polymerization method, the type of polymerization, and the polymerization conditions that can be used to produce the propylene homopolymer as described above.

The heterophasic propylene polymer material is a mixture containing a polymer I including 80 mass % or more of a monomer unit derived from propylene (provided that the total mass of the polymer I is 100 mass %) and a polymer II including a monomer unit derived from propylene and a monomer unit derived from at least one α-olefin selected from the group consisting of ethylene and C4-C12 α-olefins.

Examples of the monomer other than propylene in the heterophasic propylene polymer material include ethylene and C4+α-olefins. Examples of the C4+α-olefins include 1-butene, 1-pentene, 1-hexene, 1-heptene, 1-octene, 1-nonene, 1-decene, 1-dodecene, 4-methyl-1-pentene, and 4-methyl-1-hexene.

The heterophasic propylene polymer material can be produced through, for example, a first polymerization step of synthesizing the polymer I and a second polymerization step of synthesizing the polymer II. These polymerization steps can be carried out using the polymerization catalyst, the polymerization method, the type of polymerization, and the polymerization conditions that can be used to produce the propylene homopolymer.

The polymer I may be, for example, a propylene homopolymer, or may contain a monomer unit derived from a monomer other than propylene. Examples of the polymer I including a monomer unit derived from a monomer other than propylene include a propylene-ethylene copolymer, a propylene-1-butene copolymer, a propylene-1-hexene copolymer, a propylene-1-octene copolymer, a propylene-ethylene-1-butene copolymer, a propylene-ethylene-1-hexene copolymer, and a propylene-ethylene-1-octene copolymer.

The content of the polymer I relative to the total mass (100 mass %) of the heterophasic propylene polymer material is preferably 50 mass % or more and 99 mass % or less, more preferably 60 mass % or more and 95 mass % or less.

The polymer II includes a monomer unit derived from propylene and a monomer unit derived from at least one α-olefin selected from the group consisting of ethylene and C4-C12 α-olefins. Examples of the C4-C12 α-olefins include 1-butene, 1-pentene, 1-hexene, 1-heptene, 1-octene, 1-nonene, 1-decene, 1-dodecene, 4-methyl-1-pentene, and 4-methyl-1-hexene.

The content of the polymer II relative to the total mass (100 mass %) of the heterophasic propylene polymer material is preferably 1 mass % or more and 50 mass % or less, more preferably 5 mass % or more and 40 mass % or less.

The melt flow rate (MFR) of the propylene-based polymer measured at a temperature of 230° C. and a load of 2.16 kg is preferably 0.1 g/10 min or more, more preferably 1 g/10 min or more and 300 g/10 min or less. The MFR of the propylene-based polymer may be 5 g/10 min or more and 100 g/10 min or less, or 10 g/10 min or more and 50 g/10 min or less. The MFR is measured in accordance with the method A specified in JIS K7210-1995.

The olefin-based polymer according to this embodiment may be mixed with additives as desired to form an olefin-based resin composition. The amount of the olefin-based polymer according to this embodiment in the olefin-based resin composition is preferably 5 mass % or more and 95 mass % or less, more preferably 10 mass % or more and 90 mass % or less, still more preferably 15 mass % or more and 85 mass or less, relative to the total amount (100 mass %) of the olefin-based resin composition.

Examples of the additives include organic peroxides, hindered amine light stabilizers, cross-linkers, UV absorbers, and silane coupling agents.

### (1) Organic Peroxide

Organic peroxides are mainly used to cross-link the olefin-based polymer. Organic peroxides having a decomposition temperature (temperature at which the half-life is 1 hour) of 70 to 180° C., especially 90 to 160° C., can be used as organic peroxides. Examples of such organic peroxides include t-butylperoxy isopropyl carbonate, t-butylperoxy-2-ethylhexyl carbonate, t-butyl peroxyacetate, t-butyl peroxybenzoate, dicumyl peroxide, 2,5-dimethyl-2,5-di(t-butylperoxy) hexane, di-t-butyl peroxide, 2,5-dimethyl-2,5-di(t-butylperoxy) hexyne-3,1,1-di(t-butylperoxy)-3,3,5-trimethylcyclohexane, 1,1-di(t-butylperoxy) cyclohexane, methyl ethyl ketone peroxide, 2,5-dimethylhexyl-2,5-diperoxybenzoate, t-butyl hydroperoxide, p-menthane hydroperoxide, benzoyl peroxide, p-chlorobenzoyl peroxide, t-butylperoxyisobutyrate, hydroxyheptyl peroxide, and dicyclohexanone peroxide.

The content of the organic peroxide relative to 100 parts by mass of the olefin-based polymer according to this embodiment is preferably 0.2 parts by mass or more and 5 parts by mass or less, more preferably 0.5 parts by mass or more and 3 parts by mass or less, still more preferably 1 part by mass or more and 2 parts by mass or less. When the blending ratio of the organic peroxide is in the above range, the olefin-based polymer is cross-linked sufficiently and uniformly.

### (2) Hindered Amine Light Stabilizer

Hindered amine light stabilizers capture radical species harmful to the polymer and prevent generation of new radicals. There are various types of hindered amine light stabilizers ranging from low molecular weight to high molecular weight, and any hindered amine light stabilizer known in the related art can be used without any limitation.

Examples of hindered amine light stabilizers with low molecular weights include a hindered amine light stabilizer composed of 30 mass % of polypropylene and 70 mass % of the reaction product (molecular weight 737) of decanedioic acid bis(2,2,6,6-tetramethyl-1 (octyloxy)-4-piperidinyl) ester, 1,1-dimethylethylhydroperoxide, and octane; bis(1,2,2,6,6-pentamethyl-4-piperidyl) [[3,5-bis(1,1-dimethylethyl)-4-hydroxyphenyl]methyl]butylmalonate (molecular weight 685); a mixture (molecular weight 509) of bis(1,2,2,6,6-pentamethyl-4-piperidyl) sebacate and methyl-1,2,2,6,6-pentamethyl-4-piperidylsebacate; bis(2,2,6,6-tetramethyl-4-piperidyl) sebacate (molecular weight 481); tetrakis(2,2,6,6-tetramethyl-4-piperidyl)-1, 2, 3, 4-butanetetracarboxylate (molecular weight 791); tetrakis(1,2,2,6,6-pentamethyl-4-piperidyl)-1, 2, 3, 4-butanetetracarboxylate (molecular weight 847); a mixture (molecular weight 900) of 2,2,6,6-tetramethyl-4-piperidyl-1, 2, 3, 4-butanetetracarboxylate and tridecyl-1, 2, 3, 4-butanetetracarboxylate; and a mixture (molecular weight 900) of 1,2,2,6,6-pentamethyl-4-piperidyl-1, 2, 3, 4-butanetetracarboxylate and tridecyl-1, 2, 3, 4-butanetetracarboxylate.

Examples of hindered amine light stabilizers with high molecular weights include poly [{6-(1,1,3,3-tetramethylbutyl)amino-1,3,5-triazine-2,4-diyl}{(2,2,6,6-tetramethyl-4-piperidyl)imino}hexamethylene {(2,2,6,6-tetramethyl-4-piperidyl)imino}](molecular weight 2,000 to 3,100); a polymer (molecular weight 3,100 to 4,000) of dimethyl succinate and 4-hydroxy-2,2,6,6-tetramethyl-1-piperidineethanol; a mixture of N,N′, N″, N′″-tetrakis-(4,6-bis-(butyl-(N-methyl-2,2,6,6-tetramethylpiperidin-4-yl)amino)-triazin-2-yl)-4,7-diazadecane-1,10-diamine (molecular weight 2,286) and the polymer of dimethyl succinate and 4-hydroxy-2,2,6,6-tetramethyl-1-piperidineethanol; a polycondensation product (molecular weight 2,600 to 3,400) of dibutylamine-1,3,5-triazine-N, N′-bis(2,2,6,6-tetramethyl-4-piperidyl-1,6-hexamethylenediamine and N-(2,2,6,6-tetramethyl-4-piperidyl)butylamine, and a copolymer of ethylene and a cyclic aminovinyl compound, such as 4-acryloyloxy-2,2,6,6-tetramethylpiperidine, 4-acryloyloxy-1,2,2,6,6-pentamethylpiperidine, 4-acryloyloxy-1-ethyl-2,2,6,6-tetramethylpiperidine, 4-acryloyloxy-1-propyl-2,2,6,6-tetramethylpiperidine, 4-acryloyloxy-1-butyl-2,2,6,6-tetramethylpiperidine, 4-methacryloyloxy-2,2,6,6-tetramethylpiperidine, 4-methacryloyloxy-1,2,2,6,6-pentamethylpiperidine, 4-methacryloyloxy-1-ethyl-2,2,6,6-tetramethylpiperidine, 4-methacryloyloxy-1-butyl-2,2,6,6-tetramethylpiperidine, 4-crotonoyloxy-2,2,6,6-tetramethylpiperidine, or 4-crotonoyloxy-1-propyl-2,2,6,6-tetramethylpiperidine. These hindered amine light stabilizers may be used singly or in combination of two or more.

Among these substances, the hindered amine light stabilizer is preferably poly [{6-(1,1,3,3-tetramethylbutyl)amino-1,3,5-triazine-2,4-diyl}{(2,2,6,6-tetramethyl-4-piperidyl)imino}hexamethylene {(2,2,6,6-tetramethyl-4-piperidyl)imino}](molecular weight 2,000 to 3,100); a polymer (molecular weight 3,100 to 4,000) of dimethyl succinate and 4-hydroxy-2,2,6,6-tetramethyl-1-piperidineethanol; a mixture of N,N′, N″, N′″-tetrakis-(4,6-bis-(butyl-(N-methyl-2,2,6,6-tetramethylpiperidin-4-yl)amino)-triazin-2-yl)-4,7-diazadecane-1,10-diamine (molecular weight 2,286) and the polymer of dimethyl succinate and 4-hydroxy-2,2,6,6-tetramethyl-1-piperidineethanol; a polycondensation product (molecular weight 2,600 to 3,400) of dibutylamine-1,3,5-triazine-N, N′-bis(2,2,6,6-tetramethyl-4-piperidyl-1,6-hexamethylenediamine and N-(2,2,6,6-tetramethyl-4-piperidyl)butylamine; or a copolymer of ethylene and a cyclic aminovinyl compound. This is because these hindered amine light stabilizers are unlikely to bleed out over time during use of products. In terms of ease of producing the olefin-based resin composition, the hindered amine light stabilizer preferably has a melting point of 60° C. or higher.

The content of the hindered amine light stabilizer relative to 100 parts by mass of the olefin-based polymer according to this embodiment is preferably 0.01 parts by mass or more and 2.5 parts by mass or less, more preferably 0.01 parts by mass or more and 1.0 parts by mass or less, still more preferably 0.01 parts by mass or more and 0.5 parts by mass or less, yet still more preferably 0.01 parts by mass or more and 0.2 parts by mass or less, most preferably 0.03 parts by mass or more and 0.1 parts by mass or less.

When the content of the hindered amine light stabilizer is 0.01 parts by mass or more, the stabilization effect is sufficient. When the content of the hindered amine light stabilizer is 2.5 parts by mass or less, discoloration of the resin due to excessive addition of the hindered amine light stabilizer is unlikely to occur. The mass ratio of the organic peroxide to the hindered amine light stabilizer in the olefin-based resin composition is preferably from 1:0.01 to 1:10, more preferably from 1:0.02 to 1:6.5. This composition can significantly suppress yellowing of the resin.

### (3) Cross-Linker

Cross-linkers are effective in accelerating the cross-linking reactions and increasing the degree of cross-linking of the olefin-based polymer. Examples of cross-linkers include polyunsaturated compounds, such as polyallyl compounds and poly(meth)acryloxy compounds. Specific examples of cross-linkers include polyallyl compounds, such as triallyl isocyanurate, triallyl cyanurate, diallyl phthalate, diallyl fumarate, and diallyl maleate; poly(meth)acryloxy compounds, such as ethylene glycol diacrylate, ethylene glycol dimethacrylate, and trimethylolpropane trimethacrylate; and divinylbenzene. The content of the cross-linker relative to 100 parts by mass of the olefin-based polymer according to this embodiment is about more than 0 parts by mass and 5 parts by mass or less.

### (4) UV Absorber

Examples of UV absorbers include various types of UV absorbers, such as benzophenones, benzotriazoles, triazines, and salicylates.

Examples of benzophenone UV absorbers include 2-hydroxy-4-methoxybenzophenone, 2-hydroxy-4-methoxy-2′-carboxybenzophenone, 2-hydroxy-4-n-octoxybenzophenone, 2-hydroxy-4-n-dodecyloxybenzophenone, 2-hydroxy-4-n-octadecyloxybenzophenone, 2-hydroxy-4-benzyloxybenzophenone, 2-hydroxy-4-methoxy-5-sulfobenzophenone, 2-hydroxy-5-chlorobenzophenone, 2,4-dihydroxybenzophenone, 2, 2′-dihydroxy-4-methoxybenzophenone, 2,2′-dihydroxy-4,4′-dimethoxybenzophenone, and 2,2′, 4,4′-tetrahydroxybenzophenone.

Examples of benzotriazole UV absorbers include hydroxyphenyl-substituted benzotriazole compounds, such as 2-(2-hydroxy-5-methylphenyl)benzotriazole, 2-(2-hydroxy-5-t-butylphenyl)benzotriazole, 2-(2-hydroxy-3,5-dimethylphenyl)benzotriazole, 2-(2-methyl-4-hydroxyphenyl)benzotriazole, 2-(2-hydroxy-3-methyl-5-t-butylphenyl)benzotriazole, 2-(2-hydroxy-3,5-di-t-amylphenyl)benzotriazole, and 2-(2-hydroxy-3,5-di-t-butylphenyl)benzotriazole. Examples of triazine UV absorbers include 2-[4,6-bis(2,4-dimethylphenyl)-1,3,5-triazin-2-yl]-5-(octyloxy) phenol, and 2-(4,6-diphenyl-1,3,5-triazin-2-yl)-5-(hexyloxy) phenol. Examples of salicylate UV absorbers include phenyl salicylate and p-octylphenyl salicylate. The content of the UV absorber relative to 100 parts by mass of the olefin-based polymer according to this embodiment is preferably 2.0 parts by mass or less, more preferably 0.05 parts by mass or more and 2.0 parts by mass or less, still more preferably 0.1 parts by mass or more and 1.0 parts by mass or less, yet still more preferably 0.1 parts by mass or more and 0.5 parts by mass or less, most preferably 0.2 parts by mass or more and 0.4 parts by mass or less.

### (5) Silane Coupling Agent

Examples of silane coupling agents include γ-chloropropyltrimethoxysilane; vinyltrichlorosilane; vinyltriethoxysilane; vinyltrimethoxysilane; vinyl-tris-(β-methoxyethoxy) silane; γ-methacryloxypropyltrimethoxysilane; β-(3,4-epoxycyclohexyl)ethyltrimethoxysilane; γ-glycidoxypropyltrimethoxysilane; vinyltriacetoxysilane; γ-mercaptopropyltrimethoxysilane; γ-aminopropyltrimethoxysilane; N-β-(aminoethyl)-γ-aminopropyltrimethoxysilane, and 3-acryloxypropyltrimethoxysilane. Silane coupling agents are preferably vinyltrimethoxysilane, γ-methacryloxypropyltrimethoxysilane, and 3-acryloxypropyltrimethoxysilane. The content of the silane coupling agent relative to 100 parts by mass of the olefin-based polymer according to this embodiment is preferably more than 0 parts by mass and 5 parts by mass or less, more preferably 0.01 parts by mass or more and 4 parts by mass or less, still more preferably 0.01 parts by mass or more and 2 parts by mass or less, yet still more preferably 0.05 parts by mass or more and 1 part by mass or less.

### (6) Other Additive Components

The olefin-based resin composition may contain other additives unless the object of the present invention is significantly impaired. Examples of other additives include antioxidants, crystal nucleating agents, clarifying agents, lubricants, colorants, dispersants, fillers, fluorescent whitening agents, UV absorbers, and light stabilizers.

Examples of the method for adding additives to the olefin-based polymer according to this embodiment include known melt kneading methods. Examples of melt kneading methods include melt kneading in a single-screw extruder, a multi-screw extruder, or other devices after dry blending in a Tumbler blender, Henschel mixer, or other devices; and melt kneading in a kneader, a Banbury mixer, or other devices.

The olefin-based polymer according to this embodiment or the olefin-based resin composition containing the olefin-based polymer according to this embodiment and additives is used for, for example, sheets, containers, insulators and sheaths for, for example, electrical wires and cables, solar cell encapsulants, and other products.

The olefin-based polymer according to this embodiment or the olefin-based resin composition containing the olefin-based polymer according to this embodiment and additives can be molded into various molded bodies by known molding methods. Examples of known molding methods include extrusion, and covering extrusion for, for example, covering electrical wires and pipes.

The present invention includes the following aspects.

[1] An olefin-based polymer having an S value of 0.60 or more, the S value being calculated using formula (i):

$$[ Formula 3 ]$$

$$S = \frac{y - value at GA - y - value at LA min}{x - value at GA - x - value at LA min} / T \qquad ( i )$$

wherein LA min is a minimum at lowest x, and LA max is a minimum at highest x on a first derivative curve obtained by a Savitzky-Golay method from a molecular weight distribution curve where an x-axis represents a log value (log A) of a molecular size (A) determined by gel permeation chromatography and a y-axis represents a polymer concentration fraction (dW/d log A) against the log value. GA is a point at a highest y in a range of an x-value at LA min or more and an x-value at LA max or less, and T is an area of the molecular weight distribution curve.

[2] The olefin-based polymer according to [1], wherein the S value is 2.0 or less.

[3] The olefin-based polymer according to [1] or [2], wherein the olefin-based polymer has a crystallization temperature of 99.0° C. or higher and 105.0° C. or lower.

[4] The olefin-based polymer according to any one of [1] to [3], wherein the olefin-based polymer is a copolymer, and the number of long-chain branches (LCB) per 1,000 carbon atoms (LCB/1000C) in the copolymer is 0.19 or more and 0.25 or less.

[5] The olefin-based polymer according to any one of [1] to [4], wherein a ratio (Mz/Mw) of a z-average molecular weight (Mz) to a weight average molecular weight (Mw) determined by gel permeation chromatography is 2.5 or more and 2.8 or less.

[6] The olefin-based polymer according to any one of [1] to [5], wherein a ratio (Mw/Mn) of a weight average molecular weight (Mw) to a number average molecular weight (Mn) determined by gel permeation chromatography is 3.4 or more and 4.0 or less.

[7] The olefin-based polymer according to any one of [1] to [6], wherein the olefin-based polymer is a copolymer, and the number of trisubstituted unsaturated bonds in the copolymer is 0.001 or more and 0.010 or less.

[8] The olefin-based polymer according to any one of [1] to [7], wherein the olefin-based polymer has a limiting viscosity of 1.19 dl/g or more.

[9] The olefin-based polymer according to any one of [1] to [8], wherein the olefin-based polymer has a characteristic relaxation time of 10.2 sec or more.

[10] The olefin-based polymer according to any one of [1] to [9], wherein the olefin-based polymer is a copolymer, and the number of short-chain branches (SCB) per 1,000 carbon atoms (SCB/1000C) in the copolymer is 18.8 or less.

### EXAMPLES

The present invention will be specifically described below by way of Examples, but the present invention is not limited to these Examples. The measurements of the items in Detailed Description of Embodiments, Examples, and Comparative Examples were obtained by the methods described below.

### Method for Measuring Physical Properties

S Value, Mz/Mw, Mw/Mn

The weight average molecular weight (Mw), the number average molecular weight (Mn), and the z-average molecular weight (Mz) were determined by using GPC under the following conditions to obtain a GPC chromatogram. The baseline on the chromatogram was specified based on the description in ISO16014-1.

### Measurement Conditions

Apparatus: HLC-8321GPC/HT (available from Tosoh Corporation)

GPC column: TOSOH TSKgel GMH_{HR}-H(S) HT 7.8 I.D.×300 mm (available from Tosoh Corporation), three columns Mobile phase: ortho-dichlorobenzene (available from Wako Pure Chemical Industries, Ltd., Guaranteed Reagent) with 0.1 w/V BHT
Flow rate: 1 mL/min
Column oven temperature: 140° C.
Detection: refractive index detector (RID)
RID cell temperature: 140° C.
Sample solution injection volume: 300 UL
Sample solution concentration: 5 mg/mL

Standard substance for GPC column calibration: prepared by dissolving standard polystyrene, which was available from Tosoh Corporation, at the weight shown in Table 1 above in 5 mL of ortho-dichlorobenzene (with the same composition as the mobile phase) at room temperature

The S value was calculated by the following method using Python.

In the first step, an Anaconda version of the corresponding model is downloaded and installed, and the environment settings are made.

In the second step, the title of the first column of the electronic data of the GPC chromatogram is assigned to “x,” and the title of the second column is assigned to “y.” Next, the log M values are inputted in the second and subsequent rows in the first column, and the dwt/d (log M) values are inputted in the second and subsequent rows in the second column. The data are stored as a csv file (“data name .csv”).

In the third step, the code described below is inputted and executed by using Jupyter Notebook (Anaconda 3).

```
      # load module
      import glob
      import pandas as pd
      from scipy import signal
      # input Data
      df = pd.read_csv(‘data name.csv’)
      # execute smoothing and differentiation
      delta = df[“x”].iat[1] − df[“x”].iat[0]
      df[“dy”] = signal.savgol_filter(df[“y”],
round((0.3/delta − 1)/2) * 2 + 1, 1, deriv=1, delta=delta)
      df[“ddy”] = signal.savgol_filter(df[“y”],
round((0.6/delta − 1)/2) * 2 + 1, 2, deriv=2, delta=delta)
      # calculate S value
      l_mins = [ ]
      idxmax = df[“y”].astype(“float64”).idxmax( )
      for i in range(len(df[“ddy”]) − 1 − idxmax):
      if df.at[df.index[i + idxmax], “ddy”] < 0 and
df.at[df.index[i + idxmax + 1], “ddy”] > 0:
      l_mins.append(i + idxmax)
      if len(l_mins) < 2:
      s = 0
      else:
      first_l_min_idx = min(l_mins)
      first_l_min_x = df.at[df.index[first_l_min_idx], “x”]
      first_l_min_y = df.at[df.index[first_l_min_idx], “dy”]
      last_l_min_idx = max(l_mins)
      last_l_min_x = df.at[df.index[last_l_min_idx], “x”]
      last_l_min_y = df.at[df.index[last_l_min_idx], “dy”]
      partial_df = df.query(“@first_l_min_idx < index <
@last_l_min_idx”)
      partial_max_idx = partial_df[“dy”].idxmax( )
      partial_max_x = df.at[df.index[partial_max_idx], “x”]
      partial_max_y = df.at[df.index[partial_max_idx], “dy”]
      s = (partial_max_y − first_l_min_y)/(partial_max_x −
first_l_min_x)
      print(s)
```

Melt Tension (MT, unit: CN)

Using a melt tension tester available from Toyo Seiki Seisaku-Sho, Ltd., a molten copolymer filled in a φ 9.55 mm barrel was extruded through an orifice with a diameter of φ 2.09 mm and a length of 8 mm at a piston fall rate of 5.5 mm/min at a temperature of 190° C. The extruded molten copolymer was wound around a winding roll with a diameter of @ 50 mm while increasing the rotation speed by 40 rpm/min, and the tension just before breakage of the molten copolymer was measured. The maximum tension from the start of winding to the breakage of the filamentous resin was defined as a melt tension (MT). The larger the value of the melt tension, the higher the melt tension. A resin with high melt tension exhibits high bubble stability during inflation molding, good parison shape retention during blow molding, and small neck-in in T-die molding.

Characteristic Relaxation Time (t, unit: see)

The melt complex viscosity-angular frequency curves at 130° C., 150° C., 170° C., and 190° C. were measured under the following measurement conditions using a viscoelasticity analyzer ARES-G2 (available from TA Instruments). Samples used in the measurement were molded by using a press molding machine available from Shinto Metal Industries, Ltd. Each sample was placed in a die with a thickness of 2 mm, and circular test pieces with a diameter of 25 mm were prepared under the conditions of a preheating temperature of 150° C., a preheating time of 5 minutes, a heating temperature of 150° C., a heating time of 2 minutes, a heating pressure of 5 MPa, a cooling temperature of 25° C., and a cooling time of 5 minutes, and used.

Next, the master curve of the melt complex viscosity-angular frequency curve at 190° C. was produced from the obtained melt complex viscosity-angular frequency curve using analysis software TRIOS ver. 5.0.0 (available TA Instruments), and the obtained master curve was approximated by using the following formula to obtain the characteristic relaxation time.
n=n0/[1+(t×ω) n]
n: melt complex viscosity (unit: Pa·see)
ω: angular frequency (unit: rad/sec)
T: characteristic relaxation time (unit: see)
n0: constant (unit: Pa·see) for each ethylene-α-olefin copolymer
n: constant for each ethylene-α-olefin copolymer
Measurement Conditions
Geometry: parallel plate
Plate diameter: 25 mm
Plate interval: 1.5 to 2 mm
Strain: 5%
Angular frequency: 100 to 0.1 rad/see
Measurement atmosphere: nitrogen

Melt Complex Viscosity (n*100, unit: Pa·see)

The melt complex viscosity measured at a temperature of 150° C. and an angular frequency of 100 rad/see in the measurement of the characteristic relaxation time t was obtained.

Limiting Viscosity ([n], unit: dl/g)

The polymer was dissolved in a tetralin solvent, and the limiting viscosity was measured at 135° C. using an Ubbelohde viscometer.

The Number of Long-Chain Branches (LCB) per 1,000 Carbon Atoms (LCB/1000C) in Copolymer

LCB/1000C was determined by measuring the carbon nuclear magnetic resonance (13C-NMR) spectrum of the copolymer under the following measurement conditions.
Measurement Conditions
Apparatus: Bruker AVANCE 600
Measurement probe: 10 mm CryoProbe
Measurement solvent: 1,2-dichlorobenzene-d4
Measurement temperature: 135° C.
Measurement method: proton decoupling method
Pulse width: 45 degrees
Pulse repetition time: 4 seconds
Window functions: negative exponential function and Gaussian function
Number of scans: 5000

Method for Calculating the Number of Long-Chain Branches (LCB)

In the 13C-NMR spectrum, the peak area of the peak corresponding to methine carbon bonded to branches of 7 or more carbon atoms when the total peak area of all the peaks having peak tops from 5 to 50 ppm is set to 1,000 is defined as LCB. LCB is the number of branches of 7 or more carbon atoms per 1,000 carbon atoms in the copolymer. In the above measurement conditions, the peak area A near 38.2 ppm in analysis using the exponential function was used as a reference, and the area near 38.2 ppm was defined as the peak area A in analysis using the Gaussian function. On the basis of this, LCB was obtained from the peak area of a newly appearing peak having a peak top in the range of 38.22 to 38.27 ppm. In processing using the Gaussian function, the line broadening factor (LB) was from −3 to −0.1. The peak area of this peak is the area of signals in the range from the chemical shift of a valley between a peak at the highest magnetic field among peaks in the above range and its adjacent peak at the higher magnetic field than the peak to the chemical shift of a valley between a peak at the lowest magnetic field among peaks in the above range and its adjacent peak at the lower magnetic field than the peak. In the above measurement conditions, the position of the peak top of the peak corresponding to methine carbon bonded to hexyl branches was 38.21 ppm in the measurement of ethylene-1-octene copolymer.

The Number of Short-Chain Branches (SCB) per 1,000 Carbon Atoms (SCB/1000C) in Copolymer

In the carbon nuclear magnetic resonance (13C-NMR) spectrum measured by the above method, the peak area corresponding to methine carbon bonded to branches of 4 carbon atoms when the total peak area of all the peaks having peak tops from 5 to 50 ppm was set to 1,000 in analysis using the exponential function was calculated as a short-chain branching amount. In the above measurement conditions, SCB/1000C was determined from the total area of the peak from 13.8 to 14.0 ppm and the peak from 14.0 to 14.2 ppm.

The Number of Trisubstituted Unsaturated Bonds (/1000C) in Copolymer

The number of trisubstituted unsaturated bonds was determined by measuring the proton nuclear magnetic resonance (1H-NMR) spectrum of the copolymer under the following measurement conditions.
Measurement Conditions
Apparatus: Bruker AVANCE 600
Measurement probe: 10 mm CryoProbe
Measurement solvent: 1,2-dichlorobenzene-d4
Measurement temperature: 135° C.
Sample concentration: 60 mg/mL
Number of scans: 64

Method for Calculating the Number of Trisubstituted Unsaturated Bonds

In the 1H-NMR spectrum, the peak area corresponding to the trisubstituted unsaturated bonds when the total peak area of all the peaks having peak tops from 3.0 to −0.5 ppm was set to 1,000 was calculated as the number of trisubstituted unsaturated bonds. The peak area corresponding to the trisubstituted unsaturated bonds was obtained by using the area of the peak from 5.15 to 5.32 ppm in the above measurement conditions.

Oligomer Content (ΣCn; n=12 to 18, unit: ppm)

Oligomer components were extracted from about 1 g of the ethylene-α-olefin copolymer by ultrasonic extraction using 10 ml of THF solvent. The oligomer components were quantified by GC. The measurement apparatus and the measurement conditions are as described below.
Measurement Conditions
GC system: Shimadzu Corporation GC-2025
Column: InertCapl available from GL Sciences
(film thickness 1.50 μm, length 15 m, inner diameter 0.53 mm)
Detector (FID) temperature: 310° C.

Measurement column temperature: hold at 100° C. for 1 minute and then heat to 310° C. at 10° C./min

The total detection peak area for C12-C18 hydrocarbons in the obtained gas chromatogram chart was converted into C18 hydrocarbon concentration (ppm).

Crystallization Temperature (Tc, unit: ° C.)

The crystallization temperature was measured by the method including stages 1) to 3) below using a differential scanning calorimeter (DSC Q100, available from TA Instruments). Each crystallization temperature was determined at the exothermic peak in the heat flow curve observed in the stage 2).
1) Hold about 10 mg of a sample at 150° C. for 5 minutes in a nitrogen atmosphere.
2) Cool from 150° C. to 20° C. or 0° C. (5° C./min) and hold at 20° C. or 0° C. for 2 minutes.
3) Heat from 20° C. or 0° C. to 150° C. (5° C./min).

(The lower limit temperature was 20° C. in Examples 1 and 2 and Comparative Examples 1 and 2, and 0° C. in Examples 3 and 4 and Comparative Examples 3 and 4.)

### Example 1

### (1) Prepolymerization

The inside of a 3-liter autoclave equipped with a stirrer and purged with argon after drying under reduced pressure was brought to normal pressure, and 10.19 g of silica-supported methylaluminoxane carrier (available from Lake Materials) was added. The inside of the autoclave was then evacuated. Butane (288 g) was charged, and after the temperature in the system was increased to 70° C., 230 mg of dichloro [[(1, 2, 3, 3a, 7a-n)-1H-inden-1-ylidene](dimethylsilylene) [(1, 2, 3, 4,5-n)-2, 3, 4, 5-tetramethyl-2,4-cyclopentadiene-1-ylidene]]zirconium and 10 mL of hexane were added and stirred for one hour. Subsequently, 1.0 mL of a solution of triisobutylaluminum in hexane with a triisobutylaluminum concentration of 1 mmol/mL was added and stirred for 10 minutes. Subsequently, polymerization was carried out at 40° C. for 150 minutes while an ethylene/hydrogen mixed gas (hydrogen=0.22 mol %) was continuously supplied at a rate of 1 g/min. The reaction system was then purged with butane, ethylene, and hydrogen to provide 162.1 g of a prepolymer.

### (2) Polymerization

The inside of a 3-liter autoclave equipped with a stirrer and purged with argon after drying under reduced pressure was evacuated. Hydrogen was added such that the partial pressure of hydrogen reached 0.015 MPa, and 60 mL of 1-hexene and 681 g of butane were charged. The temperature in the system was increased to 70° C., and ethylene was then introduced such that the partial pressure of ethylene reached 0.8 MPa to stabilize the inside of the system. To this system, 1.0 mL of a solution of Pluronic L-61 (available from Aldrich) in hexane with a Pluronic L-61 concentration of 1.3 mg/mL and 1.0 mL of a solution of triisobutylaluminum in hexane with a triisobutylaluminum concentration of 1 mmol/mL were added. Subsequently, 316 mg of the prepolymer prepared in Example 1 (1) above was added. Polymerization was carried out at 70° C. for 120 minutes while an ethylene/hydrogen mixed gas (hydrogen=0.15 mol %) was continuously supplied such that the total pressure and the hydrogen concentration in the gas were maintained constant during polymerization. The reaction system was then purged with butane, ethylene, and hydrogen to provide 111.2 g of an ethylene-1-hexene copolymer. The physical properties of the obtained ethylene-α-olefin copolymer are shown in Table 1.

### Example 2

### (1) Prepolymerization

The inside of a 3-liter autoclave equipped with a stirrer and purged with argon after drying under reduced pressure was brought to normal pressure, and 31 mg of surfactant-containing particles produced by using the same method as in Example 1 (1) described in Japanese Patent No. 6295506, and 10.15 g of silica-supported methylaluminoxane carrier (available from Lake Materials) were added. The inside of the autoclave was then evacuated. Butane (288 g) was charged, and after the temperature in the system was increased to 70° C., 242 mg of dichloro [[(1, 2, 3, 3a, 7a-n)-1H-inden-1-ylidene](dimethylsilylene) [(1,2, 3, 4, 5-n)-2, 3, 4, 5-tetramethyl-2,4-cyclopentadiene-1-ylidene]]zirconium and 10 mL of hexane were added and stirred for one hour. Subsequently, 1.0 mL of a solution of triisobutylaluminum in hexane with a triisobutylaluminum concentration of 1 mmol/mL was added and stirred for 10 minutes. Subsequently, polymerization was carried out at 40° C. for 150 minutes while an ethylene/hydrogen mixed gas (hydrogen=0.20 mol %) was continuously supplied at a rate of 1 g/min. The reaction system was then purged with butane, ethylene, and hydrogen to provide 156.3 g of a prepolymer.

### (2) Polymerization

Polymerization was carried out under the same conditions as in Example 1 (2) above to provide 144 g of an ethylene-1-hexene copolymer except that 326 mg of the prepolymer prepared in Example 2 (1) was used and an ethylene/hydrogen mixed gas (hydrogen=0.17 mol %) was continuously supplied during polymerization.

### Example 3

### (1) Prepolymerization

To a 210-L reactor equipped with a stirrer and previously purged with nitrogen, 30 L of butane was added at normal temperature, and next 0.60 kg of silica-supported methylaluminoxane carrier (available from Lake Materials) was added. Subsequently, the temperature in the reactor was increased to 40° C., and 30.8 mmol of dichloro [[(1, 2, 3, 3a, 7a-n)-1H-inden-1-ylidene](dimethylsilylene) [(1, 2, 3, 4,5-n)-2, 3, 4, 5-tetramethyl-2,4-cyclopentadiene-1-ylidene]]zirconium was added and stirred for one hour. Subsequently, prepolymerization was carried out for total 9.8 hours while ethylene was supplied at a rate of 2.0 kg/h per kilogram of the carrier component, and hydrogen was supplied at a rate of 2.3 L/h (in terms of normal temperature and normal pressure) per kilogram of the carrier component. After completion of polymerization, the pressure in the reactor was allowed to drop to 0.45 MPaG while the temperature was maintained at 40° C. The pressure in the reactor was then reduced to 0.4 MPaG, and the slurry-like prepolymerization catalyst component was transferred to a dryer and dried under nitrogen flow to provide a prepolymerization catalyst component. The amount of the ethylene polymer in the prepolymerization catalyst component was 16.1 g per gram of the monomer components.

### (2) Gas Phase Polymerization

Ethylene and 1-hexene were copolymerized using a fluidized-bed gas phase polymerization reactor. The polymerization reaction temperature (Tr), the polymerization reaction pressure, the average residence time, and the gas superficial velocity were 89° C., 2.0 MPaG, 3.9 h, and 30 cm/s, respectively. While the hydrogen concentration and the 1-hexene concentration in the gas phase were maintained at 0.0025 mol and 0.0111 mol per mole of ethylene, respectively, triisobutylaluminum was supplied at a rate of 6.9 mmol/h, and AMIET 102 (Kao Corporation) was supplied at a rate of 15.5 wt ppm relative to the produced polyethylene. The prepolymerization catalyst component obtained in Example 3 (1) was supplied to the reactor such that polyethylene (LLDPE) was produced at a rate of 20.8 kg/h.

### Example 4

### (1) Gas Phase Polymerization

Gas phase polymerization was carried out under the same conditions as in Example 3 (2) except for the following: the polymerization reaction temperature, the average residence time, and the gas superficial velocity were changed to 86° C., 3.8 h, and 40 cm/s, respectively; the hydrogen concentration and the 1-hexene concentration in the gas phase were maintained at 0.0054 mol and 0.0165 mol per mole of ethylene, respectively; triisobutylaluminum was supplied at a rate of 8.6 mmol/h, and no AMIET 102 was supplied; and polyethylene was produced at a rate of 21.0 kg/h.

### Comparative Example 1

### (1) Preparation of Supported Catalyst

To a 100-mL three-neck flask previously purged with nitrogen, 5.09 g of silica-supported methylaluminoxane carrier (available from Lake Materials), 50 mL of hexane, 56.8 mg of dichloro [[(1, 2, 3, 3a, 7a-n)-1H-inden-1-ylidene](dimethylsilylene) [(1, 2, 3, 4,5-n)-2, 3, 4, 5-tetramethyl-2,4-cyclopentadiene-1-ylidene]]zirconium were then added and stirred at room temperature for one hour. Subsequently, the reaction product was left to stand, and the supernatant was removed. The solids were then washed with 50 mL of hexane. The washed solids were dried under vacuum to provide 5.12 g of a supported catalyst.

### (2) Polymerization

Polymerization was carried out under the same conditions as in Example 1 (2) above to provide 106 g of an ethylene-1-hexene copolymer except that 32 mg of the supported catalyst prepared in Comparative Example 1 (1) was used instead of the prepolymer and an ethylene/hydrogen mixed gas (hydrogen=0.23 mol %) was continuously supplied during polymerization.

### Comparative Example 2

### (1) Preparation of Solid Catalyst Component

A solid catalyst component was prepared by using the same method as in the preparation of the component (A) in Examples 1 (1) and (2) described in JP-A-2009-79180. As a result of elemental analysis, Zn=11 mass %, and F=6.0 mass %.

### (2) Prepolymerization

To a reactor equipped with a stirrer and previously purged with nitrogen, 3.95 m³ of butane heated to around 60° C. was added, and 6.0 mol of racemic-ethylenebis(1-indenyl) zirconium diphenoxide was then added. The mixture was stirred for 2 hours. After the inside of the system was stabilized, 5 kg of ethylene and 5 L of hydrogen (normal temperature and normal pressure) were added to the reactor, and 60.1 kg of the above solid catalyst component and 35.0 L of a solution of 20 wt % triisobutylaluminum diluted with n-hexane were added to the reactor to start prepolymerization. Ethylene and hydrogen (normal temperature and normal pressure) were supplied to the reactor for 30 minutes at 60 kg/hr and 30 L/hr, respectively. The reactor was then heated to 50° C., and ethylene and hydrogen (normal temperature and normal pressure) were supplied to the reactor at 180 kg/hr and 0.54 m³/hr, respectively. Prepolymerization was carried out for total 13.7 hours. After completion of prepolymerization, the reactor was purged until the pressure in the reactor reached 0.3 MPaG, and the slurry-like prepolymerization catalyst was transferred to a dryer and dried under nitrogen flow to provide a prepolymerization catalyst component containing 40.2 g of polyethylene per gram of the solid catalyst component.

### (3) Polymerization

The inside of a 3-liter autoclave equipped with a stirrer and purged with argon after drying under reduced pressure was evacuated. Hydrogen was added such that the partial pressure of hydrogen reached 0.041 MPa, and 160 mL of 1-hexene and 591 g of butane were charged. The temperature in the system was increased to 70° C., and ethylene was then introduced such that the partial pressure of ethylene reached 1.6 MPa to stabilize the inside of the system. To this system, 1.0 mL of a solution of triisobutylaluminum in hexane with a triisobutylaluminum concentration of 1 mmol/mL and 2.0 mL of a solution of triethylaluminum in hexane with a triethylaluminum concentration of 0.1 mol/L were added. Subsequently, 426 mg of the prepolymer prepared in Comparative Example 2 (1) above was added. Polymerization was carried out at 70° C. for 180 minutes while an ethylene/hydrogen mixed gas (hydrogen=0.43 mol %) was continuously supplied such that the total pressure and the hydrogen concentration in the gas were maintained constant during polymerization. The reaction system was then purged with butane, ethylene, and hydrogen to provide 87.4 g of an ethylene-1-hexene copolymer.

### Comparative Example 3

### (1) Preparation of Solid Catalyst Component

A solid catalyst component was prepared by using the same method as in Comparative Example 2 (1). As a result of elemental analysis, Zn=11 mass %, and F=5.9 mass %.

### (2) Prepolymerization

To a reactor equipped with a stirrer and previously purged with nitrogen, 4.15 m³ of butane heated to around 60° C. was added, and 6.0 mol of racemic-ethylenebis(1-indenyl) zirconium diphenoxide was then added. The mixture was stirred for 2 hours. After the inside of the system was stabilized, 5 kg of ethylene and 5 L of hydrogen (normal temperature and normal pressure) were added to the reactor, and 60.4 kg of the above solid catalyst component and 35.1 L of a solution of 20 wt % triisobutylaluminum diluted with n-hexane were added to the reactor to start prepolymerization. Ethylene and hydrogen (normal temperature and normal pressure) were supplied to the reactor for 30 minutes at 60 kg/hr and 30 L/hr, respectively. The reactor was then heated to 50° C., and ethylene and hydrogen (normal temperature and normal pressure) were supplied to the reactor at 174 kg/hr and 0.52 m³/hr, respectively. Prepolymerization was carried out for total 14.2 hours. After completion of prepolymerization, the reactor was purged until the pressure in the reactor reached 0.3 MPaG, and the slurry-like prepolymerization catalyst was transferred to a dryer and dried under nitrogen flow to provide a prepolymerization catalyst component containing 41.8 g of polyethylene per gram of the solid catalyst component.

### (3) Gas Phase Polymerization

Ethylene and 1-hexene were copolymerized using a fluidized-bed gas phase polymerization reactor. The polymerization reaction temperature (Tr), the polymerization reaction pressure, the average residence time, and the gas superficial velocity were 82° C., 2.0 MPaG, 3.7 h, and 42 cm/s, respectively. While the hydrogen concentration and the 1-hexene concentration in the gas phase were maintained at 0.0127 mol and 0.0167 mol per mole of ethylene, respectively, triisobutylaluminum and triethylamine were supplied at a rate of 8.7 mmol/h and 0.27 mmol/h, respectively. The prepolymerization catalyst component obtained in Example 3 (1) was supplied to the reactor such that polyethylene (LLDPE) was produced at a rate of 22.0 kg/h.

### Comparative Example 4

### (1) Gas Phase Polymerization

Gas phase polymerization was carried out under the same conditions as in Comparative Example 3 (3) except for the following: the reaction temperature and the average residence time were changed to 81° C. and 3.8 h, respectively; the hydrogen concentration and the 1-hexene concentration in the gas phase were maintained at 0.0184 mol and 0.0170 mol per mole of ethylene, respectively; and polyethylene (LLDPE) was produced at a rate of 21.3 kg/h.

TABLE 2

| | | | | | | | | | Number of | | | |
|---|---|---|---|---|---|---|---|---|---|---|---|---|
| | | | | | | | | | Trisubstituted | | | |
| | | | Oligomer | | | | | | Unsaturated | | | |
| | MT | η*100 | Content | S | Tc | | Mz/Mw | Mw/Mn | Bonds | [η] | T | SCB/ |
| | cN | Pa · sec | ppm | — | ° C. | LCB/1000C | — | — | /1000C | dl/g | sec | 1000C |
| Example 1 | 12.52 | 1198 | — | 1.45 | 103.5 | 0.24 | 2.7 | 3.4 | 0.006 | 1.2 | 15.6 | 10.5 |
| Example 2 | 11.24 | 1104 | — | 1.18 | 104.7 | 0.22 | 2.8 | 3.8 | 0.001 | 1.26 | 11.7 | 10.7 |
| Example 3 | — | — | 350 | 0.64 | 103.5 | 0.25 | 2.6 | 3.9 | 0.018 | 1.25 | 15.0 | 17.7 |
| Example 4 | — | — | 760 | 0.85 | 100.4 | 0.24 | 2.5 | 3.8 | 0.019 | 1.04 | 3.4 | 18.7 |
| Comparative | 8.48 | 1074 | — | 0.57 | 105.6 | 0.12 | 2.9 | 4.2 | 0.013 | 1.18 | 10.1 | 12.9 |
| Example 1 | | | | | | | | | | | | |
| Comparative | 9.65 | 1434 | — | 0.10 | 98.3 | 0.18 | 2.2 | 2.7 | 0.000 | 1.17 | 7.4 | 10.9 |
| Example 2 | | | | | | | | | | | | |
| Comparative | — | — | 1560 | 0.00 | 90.9 | 0.26 | 2.2 | 4.9 | 0.010 | 1.11 | 5.8 | 18.9 |
| Example 3 | | | | | | | | | | | | |
| Comparative | — | — | 2130 | 0.24 | 90.1 | 0.26 | 2.3 | 4.5 | 0.000 | 0.98 | 2.0 | 19.7 |
| Example 4 | | | | | | | | | | | | |

The results in Table 2 indicate that the ethylene-1-hexene copolymers in Examples 1 and 2, which satisfy all the requirements of the present invention, have relatively high melt tensions and are thus said to be easy to mold. The ethylene-1-hexene copolymers in Examples 3 and 4, which satisfy all the requirements of the present invention, have relatively low oligomer contents and are thus said to provide a better working environment and be easy to mold.

1. An olefin-based polymer comprising an S value of 0.60 or more, the S value being calculated using formula (i):
$$[ Formula 1 ]$$
$$S = \frac{y - value at GA - y - value at LA min}{x - value at GA - x - value at LA min} / T \qquad ( i )$$
wherein LA min is a minimum at lowest x, and LA max is a minimum at highest x on a first derivative curve obtained by a Savitzky-Golay method from a molecular weight distribution curve where an x-axis represents a log value (log A) of a molecular size (A) determined by gel permeation chromatography and a y-axis represents a polymer concentration fraction (dW/d log A) against the log value, and GA is a point at the highest y in the range of the x-value at LA min or more and the x-value at LA max or less, and T is the area of the molecular weight distribution curve.

2. The olefin-based polymer according to claim 1, wherein the S value is 2.0 or less.

3. The olefin-based polymer according to claim 1, wherein the olefin-based polymer has a crystallization temperature of 99.0° C. or higher and 105.0° C. or lower.

4. The olefin-based polymer according to claim 1, wherein the olefin-based polymer is a copolymer, and the number of long-chain branches (LCB) per 1,000 carbon atoms (LCB/1000C) in the copolymer is 0.19 or more and 0.25 or less.

5. The olefin-based polymer according to claim 1, wherein a ratio (Mz/Mw) of a z-average molecular weight (Mz) to a weight average molecular weight (Mw) determined by gel permeation chromatography is 2.5 or more and 2.8 or less.

6. The olefin-based polymer according to claim 1, wherein a ratio (Mw/Mn) of a weight average molecular weight (Mw) to a number average molecular weight (Mn) determined by gel permeation chromatography is 3.4 or more and 4.0 or less.

7. The olefin-based polymer according to claim 1, wherein the olefin-based polymer is a copolymer, and the number of trisubstituted unsaturated bonds in the copolymer is 0.001 or more and 0.010 or less.

8. The olefin-based polymer according to claim 1, wherein the olefin-based polymer has a limiting viscosity of 1.19 dl/g or more.

9. The olefin-based polymer according to claim 1, wherein the olefin-based polymer has a characteristic relaxation time of 10.2 sec or more.

10. The olefin-based polymer according to claim 1, wherein the olefin-based polymer is a copolymer, and the number of short-chain branches (SCB) per 1,000 carbon atoms (SCB/1000C) in the copolymer is 18.8 or less.
